(19) United States
(12) Patent Application Publication
(10) Pub. No.: US 2026/0169265 A1
(43) Pub. Date: Jun. 18, 2026

(54) OPTICAL IMAGING LENS

(71) Applicant: Genius Electronic Optical (Xiamen) Co., Ltd., Xiamen (CN)

(72) Inventors: Hai Lin, Xiamen (CN); Song Lin Yang, Xiamen (CN); Songchao Huang, Xiamen (CN); Hung-Chien Hsieh, Taichung City (TW)

(73) Assignee: Genius Electronic Optical (Xiamen) Co., Ltd., Xiamen (CN)

(21) Appl. No.: 19/034,574

(22) Filed: Jan. 23, 2025

(30) Foreign Application Priority Data
Dec. 18, 2024 (CN) 202411871179.8

(51) Int. Cl. G02B 13/00; G02B 9/34

(52) U.S. Cl. CPC G02B 13/004; G02B 9/34; G02B 13/0065

(57) ABSTRACT

An optical imaging lens includes a first lens element, a second lens element, a third lens element and a fourth lens element from an object side to an image side in order along an optical axis. The third lens element has negative refracting power, a periphery region of the object-side surface of the third lens element is convex, an optical axis region of the image-side surface of the third lens element is concave, the fourth lens element has negative refracting power, and an optical axis region of the image-side surface of the fourth lens element is convex. The lens elements included by the optical imaging lens are only the four lens elements described above to satisfy: HFOV/TL≤4.000 degrees/mm.

### BACKGROUND OF THE INVENTION

### 1. Field of the Invention

The present invention relates generally to an optical imaging lens. Specifically, the present invention is directed to a device which is mainly used for shooting images and videos, and can be applied to portable electronic products, such as an optical imaging lens which can be applied to mobile phones, cameras, tablet computers, personal digital assistant (PDA) and other electronic devices.

### 2. Description of the Prior Art

The specifications of portable electronic products are changing with each passing day, and its key component-optical imaging lens element is also developing more diversified. The application is not limited to shooting images and videos, but also satisfies the needs of telephoto shooting. However, the existing optical imaging lens design is difficult to meet the requirements of high imaging quality and telephoto function at the same time.

### SUMMARY OF THE INVENTION

Therefore, embodiments of the present invention propose an optical imaging lens of four lens elements with telephoto capability, excellent imaging quality and technical feasibility. The optical imaging lens of four lens elements of the present invention from an object side to an image side in order along an optical axis has a first lens element, a second lens element, a third lens element and a fourth lens element respectively has an object-side surface which faces toward the object side to allow imaging rays to pass through as well as an image-side surface which faces toward the image side to allow the imaging rays to pass through.

In an embodiment of the present invention, the third lens element has negative refracting power, a periphery region of the object-side surface of the third lens element is convex, an optical axis region of the image-side surface of the third lens element is concave, the fourth lens element has negative refracting power, and an optical axis region of the image-side surface of the fourth lens element is convex. Lens elements included by the optical imaging lens are only the four lens elements described above, and the optical imaging lens satisfies the following condition: HFOV/TL≤4.000 degrees/mm.

In another embodiment of the present invention, an optical axis region of the object-side surface of the second lens element is convex, the third lens element has negative refracting power, a periphery region of the object-side surface of the third lens element is convex, the fourth lens element has negative refracting power, and an optical axis region of the image-side surface of the fourth lens element is convex. Lens elements included by the optical imaging lens are only the four lens elements described above, and the optical imaging lens satisfies the following condition: HFOV*(ALT+G12+G23)≤60.000 degrees·mm.

In another embodiment of the present invention, the third lens element has negative refracting power, a periphery region of the object-side surface of the third lens element is convex, the fourth lens element has negative refracting power, and an optical axis region of the image-side surface of the fourth lens element is convex. Lens elements included by the optical imaging lens are only the four lens elements described above, and the optical imaging lens satisfies the following conditions: HFOV/TL≤4.000 degrees/mm, and HFOV*(ALT+G12+G23)≤60.000 degrees·mm.

In the optical imaging lens of the present invention, the embodiment can further selectively satisfy the following conditions:

$$TTL / ( D 11 t 21 + G 23 ) \geq 9.5 ;$$

$$[ ( BF L + G 34 ) / HFOV ] * ( T 1 + T 2 ) \geq 1.4 {mm}^{2} / degrees ;$$

$$Fno * TTL / T 1 \geq 30 \text{.000} ;$$

$$BFL / ImgH \geq 3. ;$$

$$( EFL + T 2 ) / ( AAG + T 1 ) \geq 5.5 ;$$

$$V 2 + V 3 - V 4 \geq 45. ;$$

$$( V 2 - V 4 ) * V 3 \geq 465. ;$$

$$V 1 + V 2 \geq 90. ;$$

$$( V 1 + V 2 ) / V 4 \geq 2 \text{.500} ;$$

$$( EFL + G 34 ) / T 1 \geq 8 \text{.500} ;$$

$$Fno * Img H / T 3 \geq 12.8 \; 00 ;$$

$$HFOV / ( AAG + T 3 ) \leq 13.8 degrees / mm ;$$

$$( T 2 + T 4 ) / D 22 t 32 \geq 1.8 ;$$

$$BFL / D 12 t 31 \geq 7.5 \; 00 ;$$

$$( V 1 + V 2 ) / V 4 \geq 2.5 ;$$

$$V 1 + V 2 - V 3 - V 4 \geq 15. ; and$$

$$Fno * BFL / T 1 \geq 20 \text{.000} .$$

In the present invention, T1 is a thickness of the first lens element along the optical axis; T2 is a thickness of the second lens element along the optical axis; T3 is a thickness of the third lens element along the optical axis; T4 is a thickness of the fourth lens element along the optical axis; G12 is an air gap between the first lens element and the second lens element along the optical axis; G23 is an air gap between the second lens element and the third lens element along the optical axis; G34 is an air gap between the third lens element and the fourth lens element along the optical axis; ALT is a sum of the thicknesses of four lens elements from the first lens element to the fourth lens element along the optical axis; D11t21 is defined as a distance from the object-side surface of the first lens element to the object-side surface of the second lens element along the optical axis, that is, the sum of T1 and G12; D12t31 is defined as a distance from the image-side surface of the first lens element to the object-side surface of the third lens element along the optical axis, that is, the sum of G12, T2 and G23; D22t32 is defined as a distance from the image-side surface of the second lens element to the image-side surface of the third lens element along the optical axis, that is, the sum of G23 and T3; TL is a distance from the object-side surface of the first lens element to the image-side surface of the fourth lens element along the optical axis; TTL is the distance from the object-side surface of the first lens element to an image plane along the optical axis; BFL is a distance from the image-side surface of the fourth lens element to an image plane along the optical axis; AAG is a sum of three air gaps from the first lens element to the fourth lens element along the optical axis, EFL is an effective focal length of the optical imaging lens; ImgH is an image height of the optical imaging lens, and Fno is a f-number of the optical imaging lens.

In addition, V1 is defined as a Vd Abbe number of the first lens; V2 is defined as a Vd Abbe number of the second lens; V3 is defined as a Vd Abbe number of the third lens; V4 is defined as a Vd Abbe number of the fourth lens element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-5 illustrate the methods for determining the surface shapes and for determining optical axis region or periphery region of one lens element.

FIG. 6A is a schematic diagram showing the actual ray path of the first embodiment of the optical imaging lens of the present invention.

FIG. 6B is a schematic diagram showing a simulated ray path of the first embodiment of the optical imaging lens of the present invention.

FIG. 7A illustrates the longitudinal spherical aberration on the image plane of the first embodiment.

FIG. 7B illustrates the field curvature aberration on the sagittal direction of the first embodiment.

FIG. 7C illustrates the field curvature aberration on the tangential direction of the first embodiment.

FIG. 7D illustrates the distortion of the first embodiment.

FIG. 8 illustrates a second embodiment of the optical imaging lens of the present invention.

FIG. 9A illustrates the longitudinal spherical aberration on the image plane of the second embodiment.

FIG. 9B illustrates the field curvature aberration on the sagittal direction of the second embodiment.

FIG. 9C illustrates the field curvature aberration on the tangential direction of the second embodiment.

FIG. 9D illustrates the distortion of the second embodiment.

FIG. 10 illustrates a third embodiment of the optical imaging lens of the present invention.

FIG. 11A illustrates the longitudinal spherical aberration on the image plane of the third embodiment.

FIG. 11B illustrates the field curvature aberration on the sagittal direction of the third embodiment.

FIG. 11C illustrates the field curvature aberration on the tangential direction of the third embodiment.

FIG. 11D illustrates the distortion of the third embodiment.

FIG. 12 illustrates a fourth embodiment of the optical imaging lens of the present invention.

FIG. 13A illustrates the longitudinal spherical aberration on the image plane of the fourth embodiment.

FIG. 13B illustrates the field curvature aberration on the sagittal direction of the fourth embodiment.

FIG. 13C illustrates the field curvature aberration on the tangential direction of the fourth embodiment.

FIG. 13D illustrates the distortion of the fourth embodiment.

FIG. 14 illustrates a fifth embodiment of the optical imaging lens of the present invention.

FIG. 15A illustrates the longitudinal spherical aberration on the image plane of the fifth embodiment.

FIG. 15B illustrates the field curvature aberration on the sagittal direction of the fifth embodiment.

FIG. 15C illustrates the field curvature aberration on the tangential direction of the fifth embodiment.

FIG. 15D illustrates the distortion of the fifth embodiment.

FIG. 16 illustrates a sixth embodiment of the optical imaging lens of the present invention.

FIG. 17A illustrates the longitudinal spherical aberration on the image plane of the sixth embodiment.

FIG. 17B illustrates the field curvature aberration on the sagittal direction of the sixth embodiment.

FIG. 17C illustrates the field curvature aberration on the tangential direction of the sixth embodiment.

FIG. 17D illustrates the distortion of the sixth embodiment.

FIG. 18 illustrates a seventh embodiment of the optical imaging lens of the present invention.

FIG. 19A illustrates the longitudinal spherical aberration on the image plane of the seventh embodiment.

FIG. 19B illustrates the field curvature aberration on the sagittal direction of the seventh embodiment.

FIG. 19C illustrates the field curvature aberration on the tangential direction of the seventh embodiment.

FIG. 19D illustrates the distortion of the seventh embodiment.

FIG. 20 illustrates an eighth embodiment of the optical imaging lens of the present invention.

FIG. 21A illustrates the longitudinal spherical aberration on the image plane of the eighth embodiment.

FIG. 21B illustrates the field curvature aberration on the sagittal direction of the eighth embodiment.

FIG. 21C illustrates the field curvature aberration on the tangential direction of the eighth embodiment.

FIG. 21D illustrates the distortion of the eighth embodiment.

FIG. 22 shows the optical data of the first embodiment of the optical imaging lens.

FIG. 23 shows the aspheric surface data of the first embodiment.

FIG. 24 shows the optical data of the second embodiment of the optical imaging lens.

FIG. 25 shows the aspheric surface data of the second embodiment.

FIG. 26 shows the optical data of the third embodiment of the optical imaging lens.

FIG. 27 shows the aspheric surface data of the third embodiment.

FIG. 28 shows the optical data of the fourth embodiment of the optical imaging lens.

FIG. 29 shows the aspheric surface data of the fourth embodiment.

FIG. 30 shows the optical data of the fifth embodiment of the optical imaging lens.

FIG. 31 shows the aspheric surface data of the fifth embodiment.

FIG. 32 shows the optical data of the sixth embodiment of the optical imaging lens.

FIG. 33 shows the aspheric surface data of the sixth embodiment.

FIG. 34 shows the optical data of the seventh embodiment of the optical imaging lens.

FIG. 35 shows the aspheric surface data of the seventh embodiment.

FIG. 36 shows the optical data of the eighth embodiment of the optical imaging lens.

FIG. 37 shows the aspheric surface data of the eighth embodiment.

FIG. 38 shows some important ratios in the embodiments.

### DETAILED DESCRIPTION

The terms “optical axis region”, “periphery region”, “concave”, and “convex” used in this specification and claims should be interpreted based on the definition listed in the specification by the principle of lexicographer.

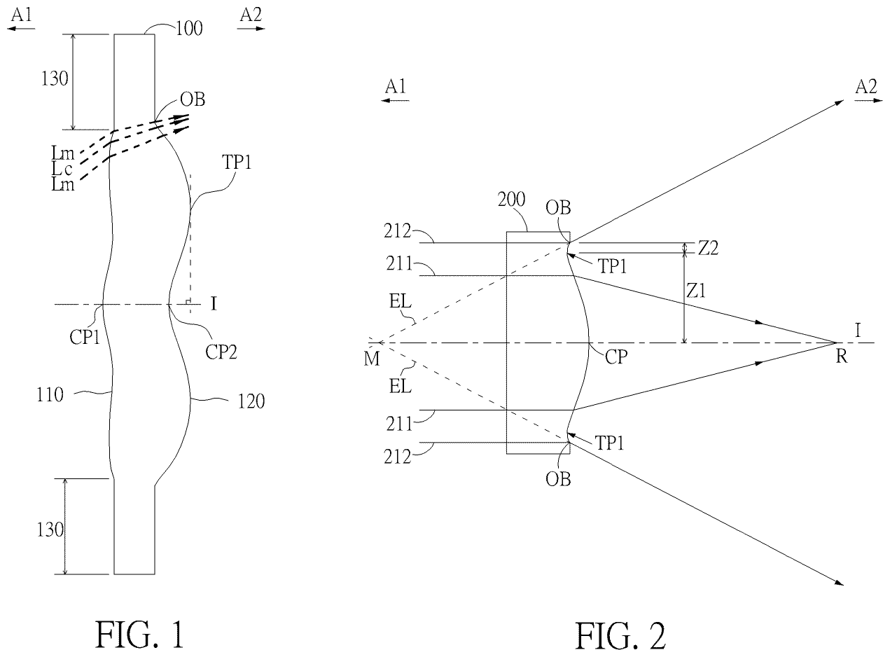

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex-(concave-) region,” can be used alternatively.

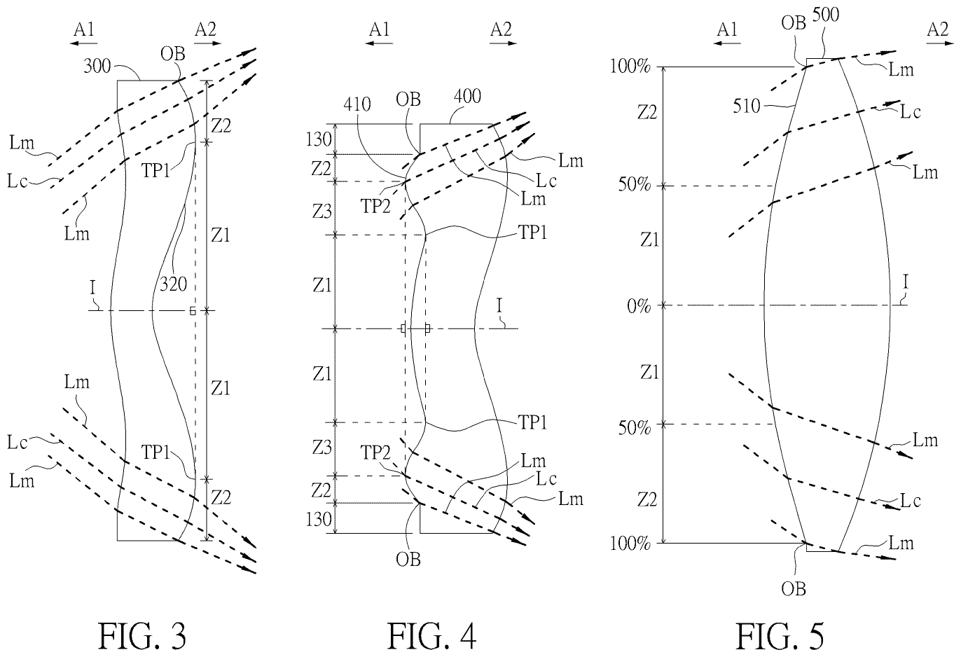

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

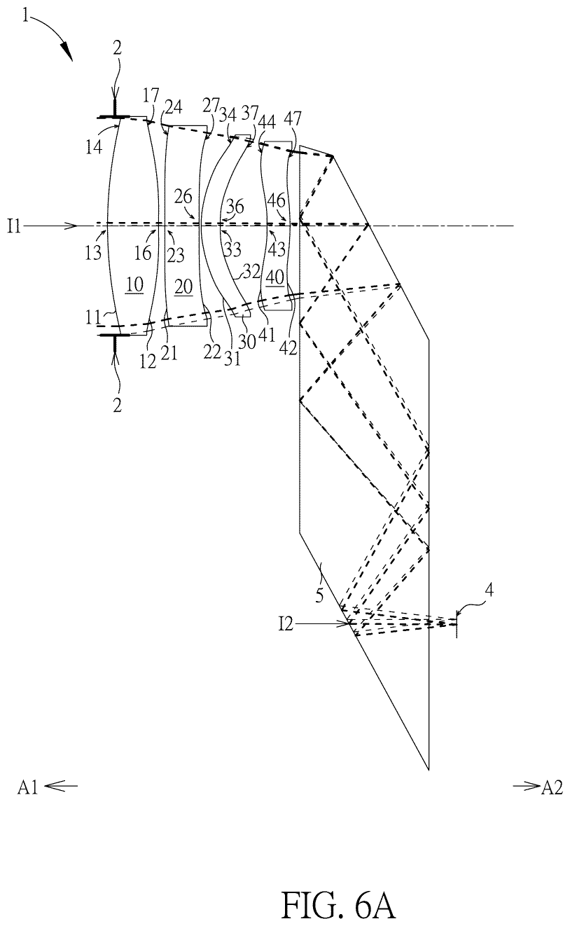

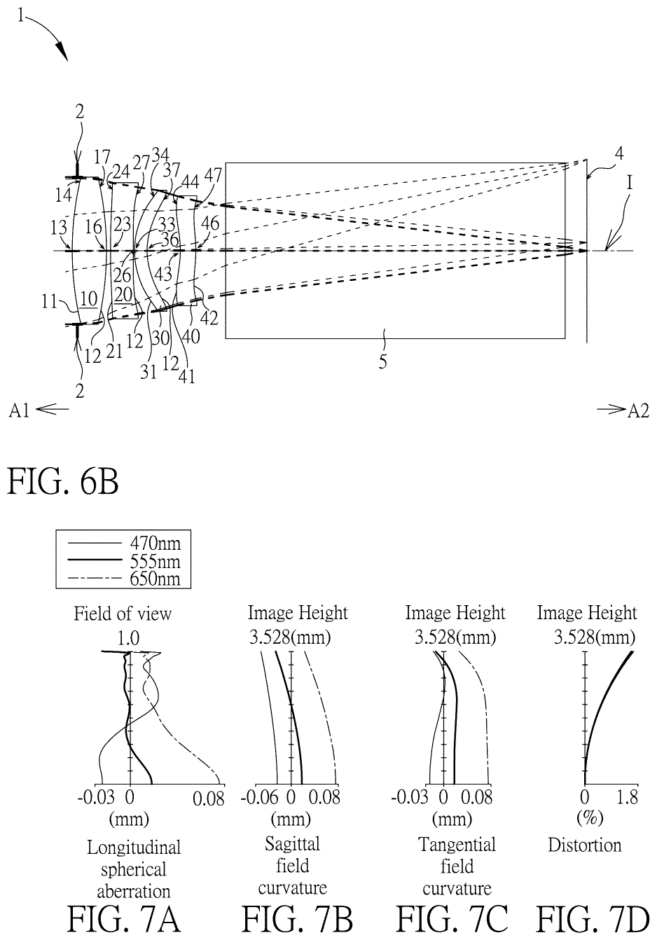

FIG. 6A is a schematic diagram showing the actual ray path of the first embodiment of the optical imaging lens of the present invention. As shown in FIG. 6A, the optical imaging lens 1 of four lens elements of the present invention, sequentially located from an object side A1 (where an object is located) to an image side A2 along an optical axis I, has a first lens element 10, an aperture stop (ape. stop) 2, a second lens element 20, a third lens element 30, a fourth lens element 40, and an image plane 4. Generally speaking, the first lens element 10, the second lens element 20, the third lens element 30 and the fourth lens element 40 may be made of a transparent plastic material but the present invention is not limited to this, and each has an appropriate refracting power. In the present invention, lens elements having refracting power included by the optical imaging lens 1 are only the four lens elements described above. The optical axis I is the optical axis of the entire optical imaging lens 1, and the optical axis of each of the lens elements coincides with the optical axis of the optical imaging lens 1.

Furthermore, the optical imaging lens 1 includes an aperture stop (ape. stop) 2 disposed in an appropriate position. In FIG. 6A, the aperture stop 2 is disposed between the object side A1 and the first lens element 10. When light emitted or reflected by an object (not shown) which is located at the object side A1 enters the optical imaging lens 1 of the present invention, it forms a clear and sharp image on the image plane 4 at the image side A2 after passing through the aperture stop 2, the first lens element 10, the second lens element 20, the third lens element 30 and the fourth lens element 40.

In order to meet the requirement of thinness, an optical bending element 5 is arranged between the fourth lens element 40 and the filter 3 or the image plane 4, and the optical axis I is bent into a first optical axis I1 and a second optical axis 12 which are not coincident with the first optical axis I1. The optical bending element 5 can be a prism, a mirror or other appropriate reflecting elements. Setting the optical bending element 5 can reduce the overall thickness of the optical imaging lens. In addition, please refer to FIG. 6B. FIG. 6B shows a schematic diagram of the simulated ray path of the first embodiment of the optical imaging lens of the present invention, in which FIG. 6B can be regarded as the result of simplifying the schematic diagram of the actual ray path shown in FIG. 6A. In addition, the actual ray path is shown in FIG. 6A, not in FIG. 6B. However, in optical simulation, it is simpler to simulate/calculate the ray path shown in FIG. 6B. Moreover, the simulation/calculation results of the ray path shown in FIG. 6B are consistent with those of FIG. 6A. Except for the optical bending element 5, the parameters such as material and surface shape of the other lens elements included in the first embodiment are the same. In order to understand the characteristics of the present invention more easily, in the following paragraphs, the ray path of each embodiment will be presented mainly by simulating the ray path (that is, in a way similar to that depicted in FIG. 6B). However, it can be understood that the shape of the optical bending element 5 included in the simulated ray path of each embodiment can be replaced by other shapes as required, and is not limited to the shape shown in the drawing.

In some embodiments of the present invention, the optional filter 3 may be placed between the optical bending element 5 and the image plane 4, and it may be a filter of various suitable functions, for example, the filter 3 may be an infrared cut-off filter (IR cut-off filter), for prohibiting the infrared rays from being transmitted to the image plane 4 to affect the image quality.

Each lens element in the optical imaging lens 1 of the present invention has an object-side surface facing toward the object side A1 as well as an image-side surface facing toward the image side A2. For example, the first lens element 10 has an object-side surface 11 and an image-side surface 12; the second lens element 20 has an object-side surface 21 and an image-side surface 22; the third lens element 30 has an object-side surface 31 and an image-side surface 32; the fourth lens element 40 has an object-side surface 41 and an image-side surface 42. In addition, each object-side surface and image-side surface in the optical imaging lens 1 of the present invention has an optical axis region and a periphery region.

Each lens element in the optical imaging lens 1 of the present invention further has a thickness T along the optical axis I. For example, the first lens element 10 has a first lens element thickness T1, the second lens element 20 has a second lens element thickness T2, the third lens element 30 has a third lens element thickness T3, the fourth lens element 40 has a fourth lens element thickness T4. Therefore, the sum of the thicknesses of four lens elements from the first lens element 10 to the fourth lens element 40 in the optical imaging lens 1 along the optical axis I is ALT=T1+T2+T3+T4.

In addition, between two adjacent lens elements in the optical imaging lens 1 of the present invention there may be an air gap along the optical axis I. For example, there is an air gap G12 between the first lens element 10 and the second lens element 20, an air gap G23 between the second lens element 20 and the third lens element 30, an air gap G34 between the third lens element 30 and the fourth lens element 40. Therefore, the sum of three air gaps from the first lens element 10 to the fourth lens element 40 along the optical axis I is AAG=G12+G23+G34.

In addition, a distance from the object-side surface 11 of the first lens element 10 to the image plane 4 along the optical axis I is TTL, namely a system length of the optical imaging lens 1; an effective focal length of the optical imaging lens 1 is EFL; a distance from the object-side surface 11 of the first lens element 10 to the image-side surface 42 of the fourth lens element 40 along the optical axis I is TL; HFOV stands for the half field of view which is half of the field of view of the entire optical imaging lens 1; ImgH is an image height of the optical imaging lens 1, and Fno is a f-number of the optical imaging lens 1.

When the filter 3 is placed between optical bending element 5 and the image plane 4, an air gap between optical bending element 5 and the image-side surface 42 of the fourth lens element 40 along the optical axis I is G4P; a distance along the optical axis I from the object-side surface of the optical bending element 5 to the image plane 4 is TP; a thickness of the filter 3 along the optical axis I is TF; an air gap between the filter 3 and the image plane 4 along the optical axis I is GFP; and a distance from the image-side surface 42 of the fourth lens element 40 to the image plane 4 along the optical axis I is BFL, namely a back focal length of the optical imaging lens 1. Therefore, BFL=G4P+TP. In some embodiments of the present invention, it is also possible to omit the filter 3, that is, along the optical axis I, the optical bending element 5 is directly adjacent to the image plane 4, and there is no filter between the optical bending element 5 and the image plane 4.

Another definition: D11t21 is defined as a distance from the object-side surface 11 of the first lens element 10 to the object-side surface 21 of the second lens element 20 along the optical axis I, that is, the sum of T1 and G12; D22t32 is defined as a distance from the image-side surface 22 of the second lens element 20 to the image-side surface 32 of the third lens element 30 along the optical axis I, that is, the sum of G23 and T3; D12t31 is defined as a distance from the image-side surface 12 of the first lens element 10 to the object-side surface 31 of the third lens element 30 along the optical axis I, that is, the sum of G12, T2 and G23; D31t42 is defined as a distance from the object-side surface 31 of the third lens element 30 to the image-side surface 42 of the fourth lens element 40 along the optical axis I, that is, the sum of T3, G34 and T4; D21t31 is defined as a distance from the object-side surface 21 of the second lens element 20 to the object-side surface 31 of the third lens element 30 along the optical axis I, that is, the sum of T2 and G23.

Furthermore, a focal length of the first lens element 10 is f1; a focal length of the second lens element 20 is f2; a focal length of the third lens element 30 is f3; a focal length of the fourth lens element 40 is f4; and refractive index of the first lens element 10 is n1; and refractive index of the second lens element 20 is n2; a nd refractive index of the third lens element 30 is n3; a nd refractive index of the fourth lens element 40 is n4; a Vd Abbe number of the first lens element 10 is V1; a Vd Abbe number of the second lens element 20 is V2; a Vd Abbe number of the third lens element 30 is V3; and a Vd Abbe number of the fourth lens element 40 is V4. The material parameters of the lens element disclosed in the optical data sheet of the example are in the format of nd refractive index and Vd Abbe number of the international glass code, so that those skilled in the art can know the specific material implementation, where nd is the refractive index of the substance at 587.56 nm of the D helium yellow line, Vd is calculated based on the refractive index of a substance at the wavelengths of d, F and C of Fraunhofer spectrum. The focal length value disclosed in the optical data table of the example is calculated based on the refractive index of the band implemented by the optical system, while the primary wavelength of the embodiment of the invention is 555 nm, so the focal length value of the invention is calculated based on the refractive index of the material at 555 nm.

### First Embodiment

Please refer to FIG. 6A which illustrates the first embodiment of the optical imaging lens 1 of the present invention. Please refer to FIG. 7A for the longitudinal spherical aberration on the image plane 4 of the first embodiment; please refer to FIG. 7B for the field curvature aberration on the sagittal direction; please refer to FIG. 7C for the field curvature aberration on the tangential direction; and please refer to FIG. 7D for the distortion aberration. The Y axis of the spherical aberration in each embodiment is “field of view” for 1.0. The Y axis of the field curvature aberration and the distortion in each embodiment stands for “image height” (ImgH), and an image height in the first embodiment is 3.528 mm.

The optical imaging lens 1 of the first embodiment is mainly composed of an aperture 2, four lens elements with refracting power, an optical bending element 5 and an image plane 4. The aperture 2 of the first embodiment is arranged on the side of the first lens element 10 facing the object side A1, that is, between the object side A1 and the first lens element 10.

The first lens element 10 has positive refracting power. The optical axis region 13 of the object-side surface 11 of the first lens element 10 is convex, the periphery region 14 of the object-side surface 11 of the first lens element 10 is convex, and the optical axis region 16 of the image-side surface 12 of the first lens element 10 is convex, and the periphery region 17 of the image-side surface 12 of the first lens element 10 is convex. Both the object-side surface 11 and the image-side surface 12 of the first lens element 10 are spherical, but not limited to this.

The second lens element 20 has positive refracting power. The optical axis region 23 of the object-side surface 21 of the second lens element 20 is convex, the periphery region 24 of the object-side surface 21 of the second lens element 20 is convex, the optical axis region 26 of the image-side surface 22 of the second lens element 20 is convex, and the periphery region 27 of the image-side surface 22 of the second lens element 20 is concave. Both the object-side surface 21 and the image-side surface 22 of the second lens element 20 are aspheric, but it is not limited to this.

The third lens element 30 has negative refracting power, the optical axis region 33 of the object-side surface 31 of the third lens element 30 is convex, the periphery region 34 of the object-side surface 31 of the third lens element 30 is convex, the optical axis region 36 of the image-side surface 32 of the third lens element 30 is concave, and the periphery region 37 of the image-side surface 32 of the third lens element 30 is concave. Both the object-side surface 31 and the image-side surface 32 of the third lens element 30 are aspheric, but it is not limited to this.

The fourth lens element 40 has negative refracting power, the optical axis region 43 of the object-side surface 41 of the fourth lens element 40 is concave, the periphery region 44 of the object-side surface 41 of the fourth lens element 40 is convex, the optical axis region 46 of the image-side surface 42 of the fourth lens element 40 is convex, and the periphery region 47 of the image-side surface 42 of the fourth lens element 40 is concave. The object-side surface 41 and image-side surface 42 of the fourth lens element 40 are aspheric, but it is not limited to this. The optical bending element 5 is arranged between the image-side surface 42 of the fourth lens element 40 and the image plane 4.

In the optical imaging lens 1 of the present invention, the object-side surface 11 and the image-side surface 12 of the first lens element 10 are spherical, and all the other six curved surfaces of the object-side surfaces 21/31/41 and the image-side surfaces 22/32/42 from the second lens element 20 to the fourth lens element 40 are aspheric, but they are not limited to this. If aspheric, these aspheric surfaces are defined by the following formula:

$$Z ( Y ) = \frac{{Y}^{2}}{R} / ( 1 + \sqrt{1 - ( 1 + K ) \frac{{Y}^{2}}{R}} ) + {\sum }_{i = 1}^{n} {a}_{i} \times {Y}^{i}$$

In which:
Y represents a perpendicular distance from a point on the aspheric surface to the optical axis;
Z represents the depth of an aspheric surface (the perpendicular distance between the point of the aspheric surface at a distance Y from the optical axis and the tangent plane of the vertex of the aspheric surface along the optical axis);
R represents the radius of curvature of the lens element surface;
K is a conic constant; and
aᵢ is the aspheric coefficient of the i^{th} order, the a₂ coefficients of each example are 0, so they are not recorded in the aspheric data table of each example.

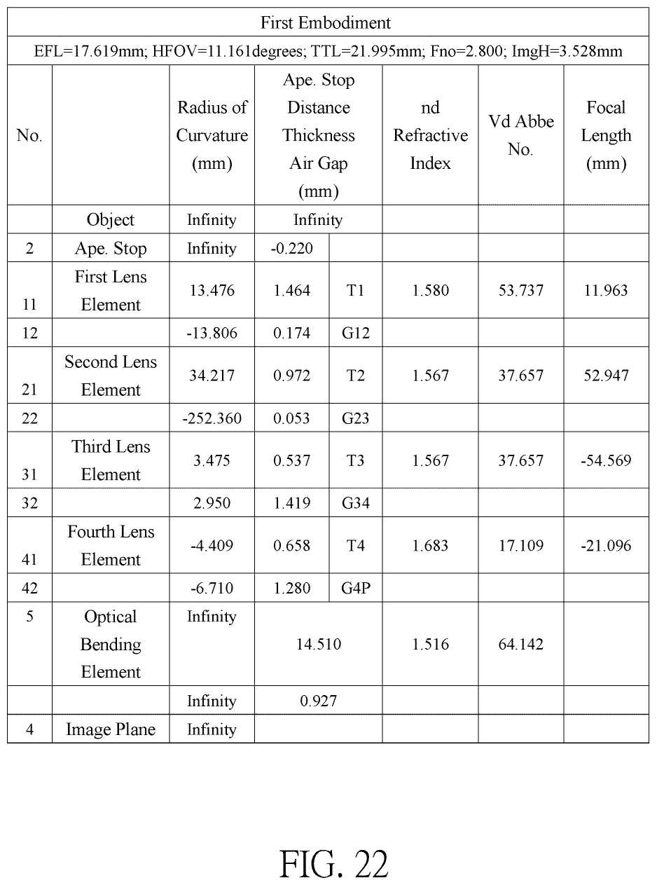

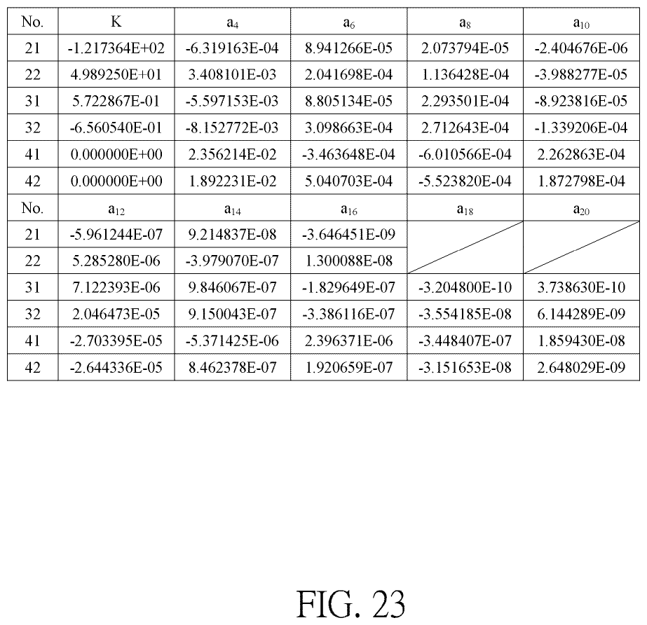

The optical data of the optical imaging lens of the first embodiment is shown in FIG. 22. FIG. 23 shows the detailed aspheric data of the first embodiment. It is worth noting that the aspheric data includes six curved surfaces of the object-side surfaces 21/31/41 and the image-side surfaces 22/32/42 in the second lens element 20 to the fourth lens element 40, since both the object-side surface 11 and the image-side surface of the first lens element 10 are spherical, so they are not recorded in FIG. 23, and the same applies to the following embodiments. In the present embodiments of the optical imaging lens, a f-number of the entire optical imaging lens element is Fno, EFL is an effective focal length, HFOV stands for the half field of view which is half of the field of view of the entire optical imaging lens, and the unit for the radius of curvature, the thickness and the focal length is in millimeters (mm). In this embodiment, EFL=17.619 mm; HFOV=11.161 degrees; TTL=21.995 mm; Fno=2.800; ImgH=3.528 mm.

### Second Embodiment

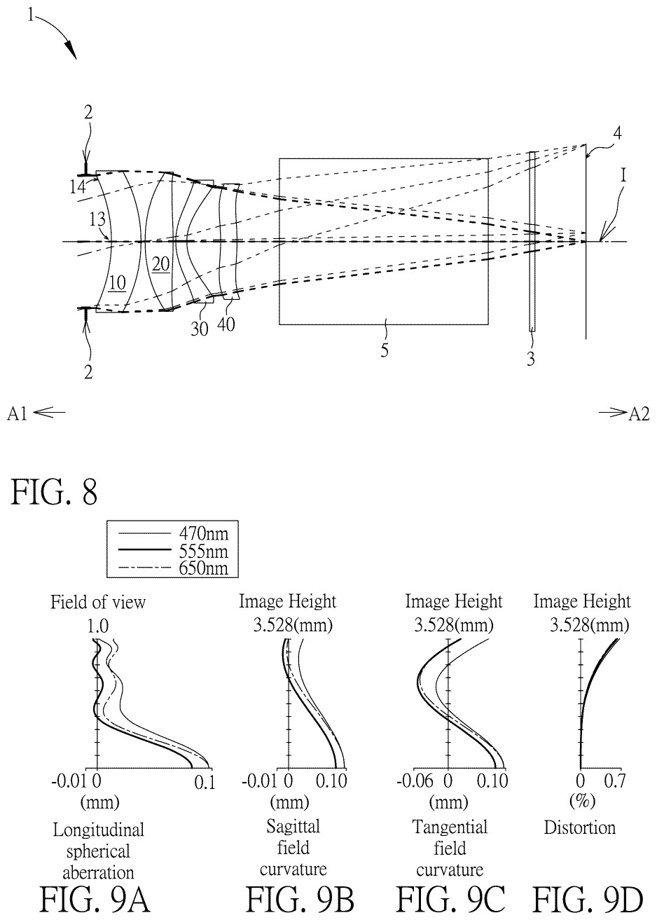

Please refer to FIG. 8 which illustrates the second embodiment of the optical imaging lens 1 of the present invention. It is noted that from the second embodiment to the following embodiments, in order to simplify the figures, only the components different from what the first embodiment has, and the basic lens elements will be labeled in figures. Other components that are the same as what the first embodiment has, such as the object-side surface, the image-side surface, the optical axis region and the periphery region will be omitted in the following embodiments. Please refer to FIG. 9A for the longitudinal spherical aberration on the image plane 4 of the second embodiment, please refer to FIG. 9B for the field curvature aberration on the sagittal direction, please refer to FIG. 9C for the field curvature aberration on the tangential direction, and please refer to FIG. 9D for the distortion aberration. The components in this embodiment are similar to those in the first embodiment, but the optical data such as the radius of curvature, the lens thickness, the aspheric surface or the back focal length in this embodiment are different from the optical data in the first embodiment. In addition, in this embodiment, the optical axis region 13 of the object-side surface 11 of the first lens element 10 is concave, the periphery region 14 of the object-side surface 11 of the first lens element 10 is concave, and this embodiment includes the filter 3, which is arranged between the optical bending element 5 and the image plane 4.

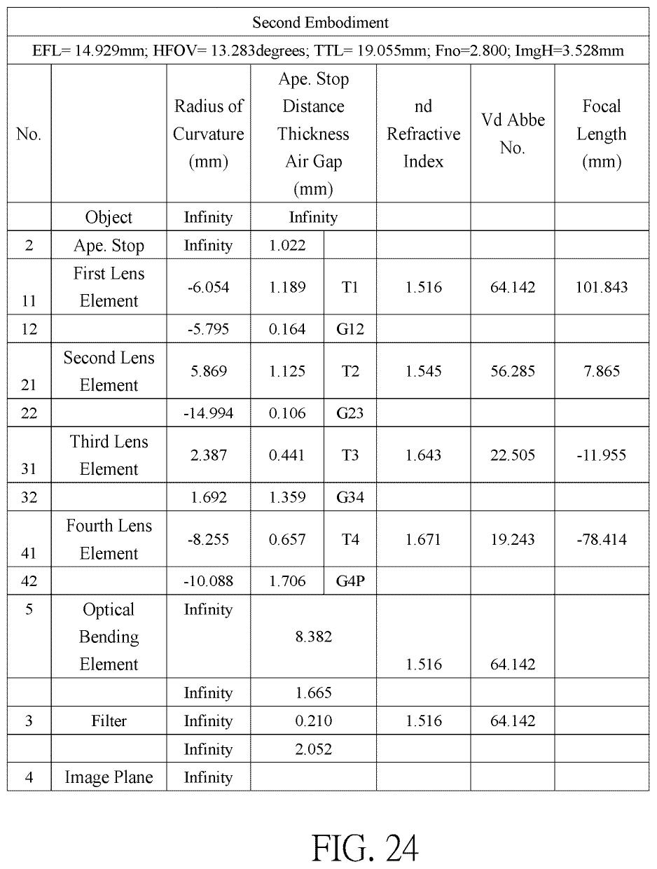

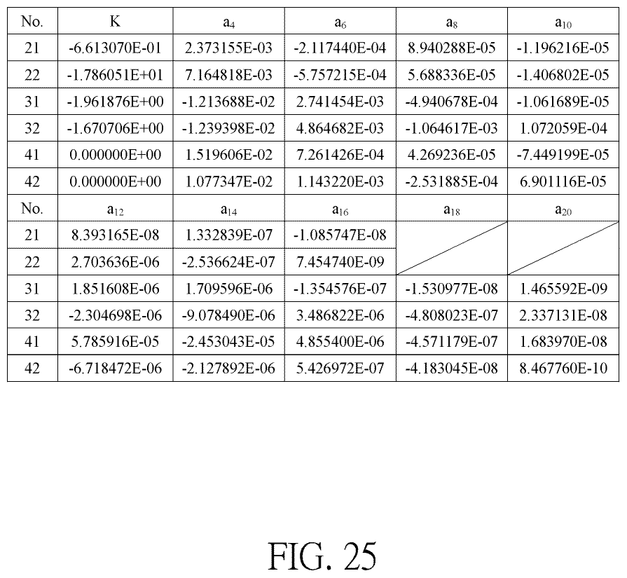

The optical data of the second embodiment of the optical imaging lens are shown in FIG. 24 while the aspheric surface data are shown in FIG. 25. In this embodiment, EFL=14.929 mm; HFOV=13.283 degrees; TTL=19.055 mm; Fno=2.800; ImgH=3.528 mm. In particular: 1. The system length TTL of this embodiment is shorter than that of the first embodiment; 2. The distortion aberration of this embodiment is smaller than that of the first embodiment.

### Third Embodiment

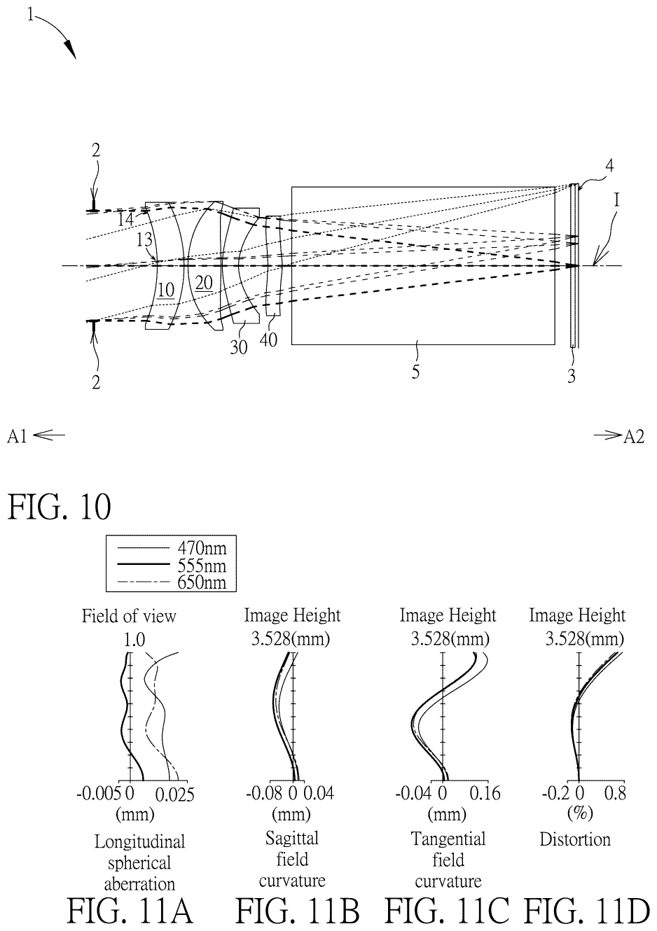

Please refer to FIG. 10 which illustrates the third embodiment of the optical imaging lens 1 of the present invention. Please refer to FIG. 11A for the longitudinal spherical aberration on the image plane 4 of the third embodiment; please refer to FIG. 11B for the field curvature aberration on the sagittal direction; please refer to FIG. 11C for the field curvature aberration on the tangential direction; and please refer to FIG. 11D for the distortion aberration. The components in this embodiment are similar to those in the first embodiment, but the optical data such as the radius of curvature, the lens thickness, the aspheric surface or the back focal length in this embodiment are different from the optical data in the first embodiment. In addition, in this embodiment, the optical axis region 13 of the object-side surface 11 of the first lens element 10 is concave, the periphery region 14 of the object-side surface 11 of the first lens element 10 is concave, and this embodiment includes the filter 3, which is arranged between the optical bending element 5 and the image plane 4.

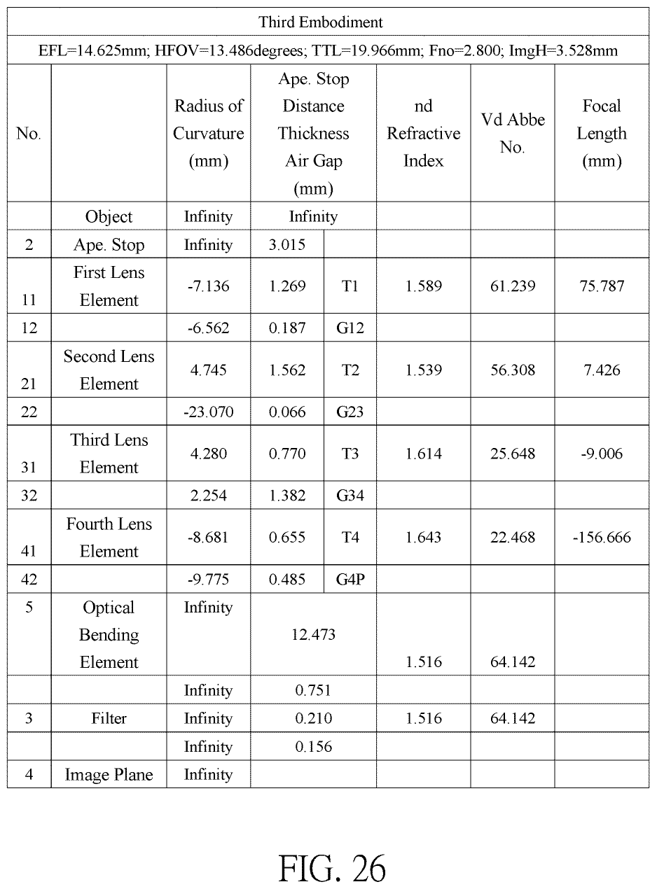

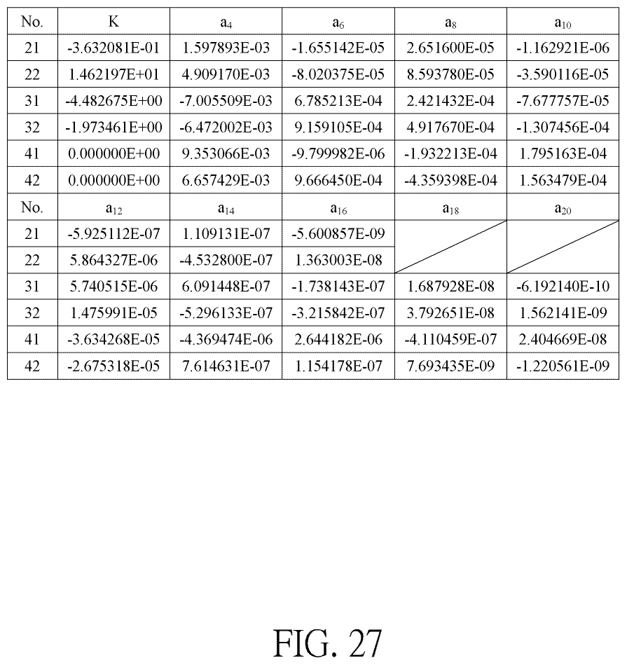

The optical data of the third embodiment of the optical imaging lens are shown in FIG. 26 while the aspheric surface data are shown in FIG. 27. In this embodiment, EFL=14.625 mm; HFOV=13.486 degrees; TTL=19.966 mm; Fno=2.800; ImgH=3.528 mm. In particular: 1. The system length TTL of this embodiment is shorter than that of the first embodiment; 2. The longitudinal spherical aberration of this embodiment is smaller than that of the first embodiment; 3. The distortion aberration of this embodiment is better than that of the first embodiment.

### Fourth Embodiment

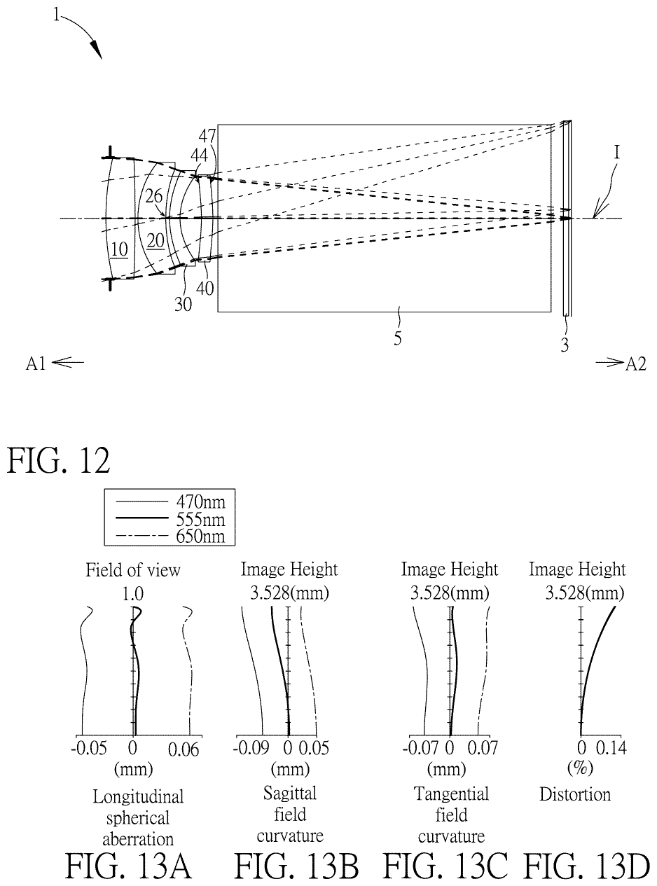

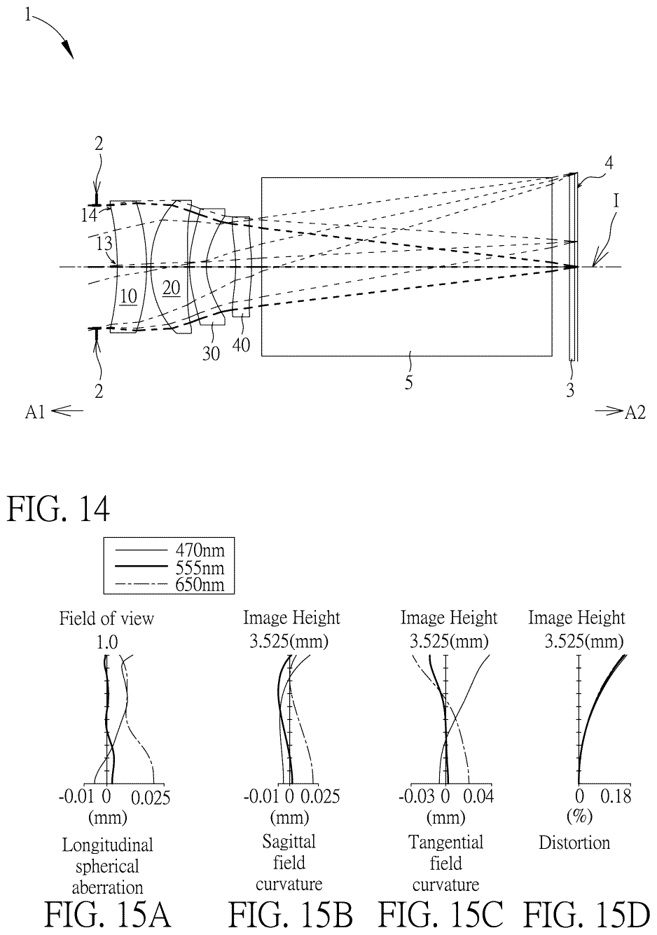

Please refer to FIG. 12 which illustrates the fourth embodiment of the optical imaging lens 1 of the present invention. Please refer to FIG. 13A for the longitudinal spherical aberration on the image plane 4 of the fourth embodiment; please refer to FIG. 13B for the field curvature aberration on the sagittal direction; please refer to FIG. 13C for the field curvature aberration on the tangential direction; and please refer to FIG. 13D for the distortion aberration. The components in this embodiment are similar to those in the first embodiment, but the optical data such as the radius of curvature, the lens thickness, the aspheric surface or the back focal length in this embodiment are different from the optical data in the first embodiment. In addition, in this embodiment, the optical axis region 26 of the image-side surface 22 of the second lens element 20 is concave, the periphery region 44 of the object-side surface 41 of the fourth lens element 40 is concave, the periphery region 47 of the image-side surface 42 of the fourth lens element 40 is convex, and this embodiment includes the filter 3, which is arranged between the optical bending element 5 and the image plane 4.

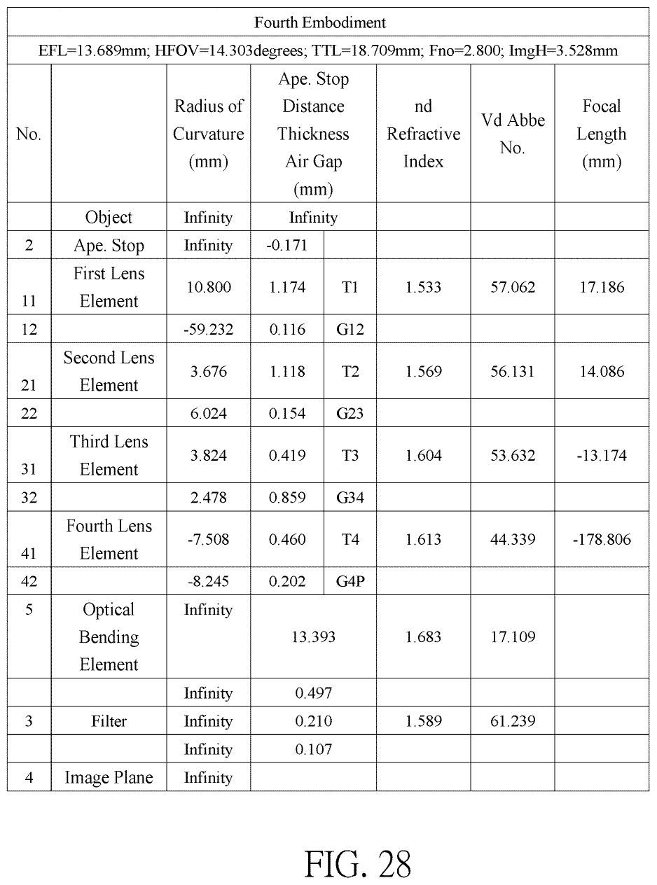

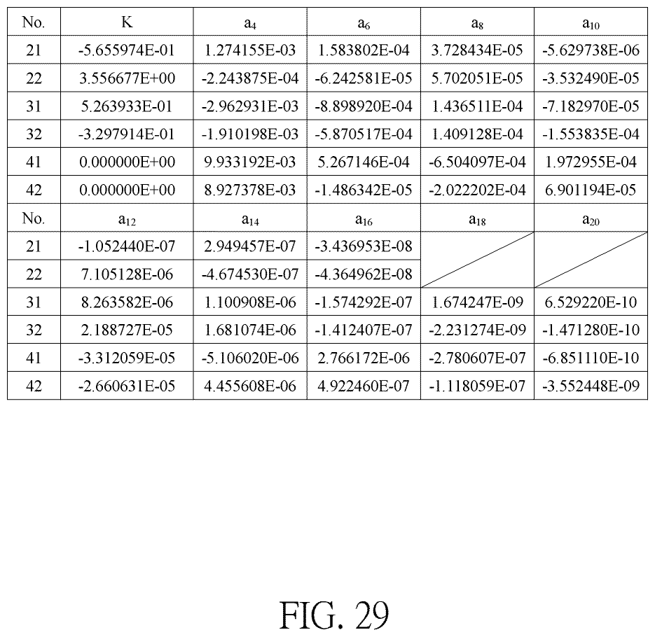

The optical data of the fourth embodiment of the optical imaging lens are shown in FIG. 28 while the aspheric surface data are shown in FIG. 29. In this embodiment, EFL=13.689 mm; HFOV=14.303 degrees; TTL=18.709 mm; Fno=2.800; ImgH=3.528 mm. In particular: 1. The system length TTL of this embodiment is shorter than that of the first embodiment; 2. The longitudinal spherical aberration of this embodiment is smaller than that of the first embodiment.

### Fifth Embodiment

Please refer to FIG. 14 which illustrates the fifth embodiment of the optical imaging lens 1 of the present invention. Please refer to FIG. 15A for the longitudinal spherical aberration on the image plane 4 of the fifth embodiment; please refer to FIG. 15B for the field curvature aberration on the sagittal direction; please refer to FIG. 15C for the field curvature aberration on the tangential direction, and please refer to FIG. 15D for the distortion aberration. The components in this embodiment are similar to those in the first embodiment, but the optical data such as the radius of curvature, the lens thickness, the aspheric surface or the back focal length in this embodiment are different from the optical data in the first embodiment. In addition, in this embodiment, the optical axis region 13 of the object-side surface 11 of the first lens element 10 is concave, the periphery region 14 of the object-side surface 11 of the first lens element 10 is concave, and this embodiment includes the filter 3, which is arranged between the optical bending element 5 and the image plane 4.

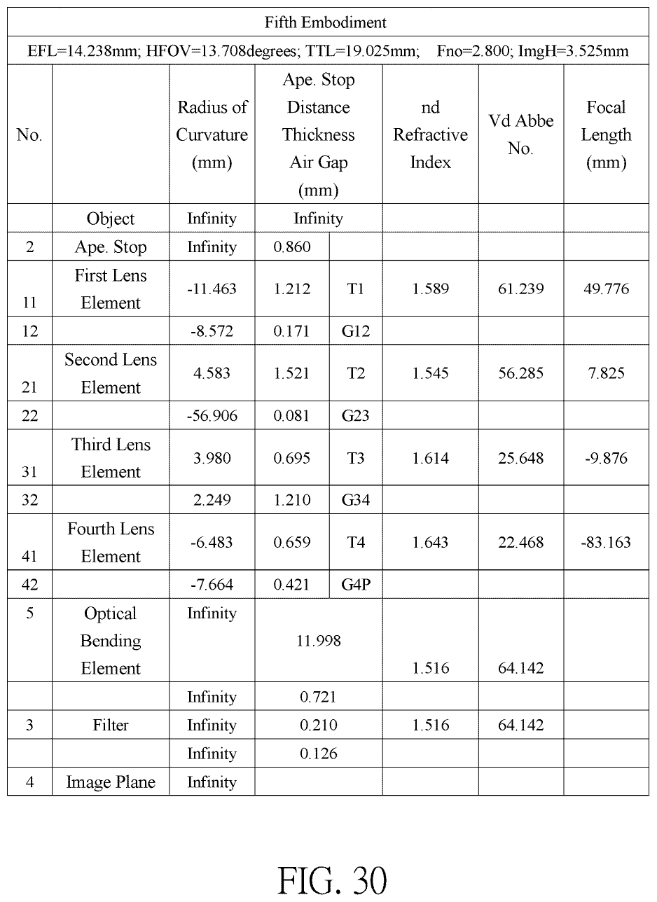

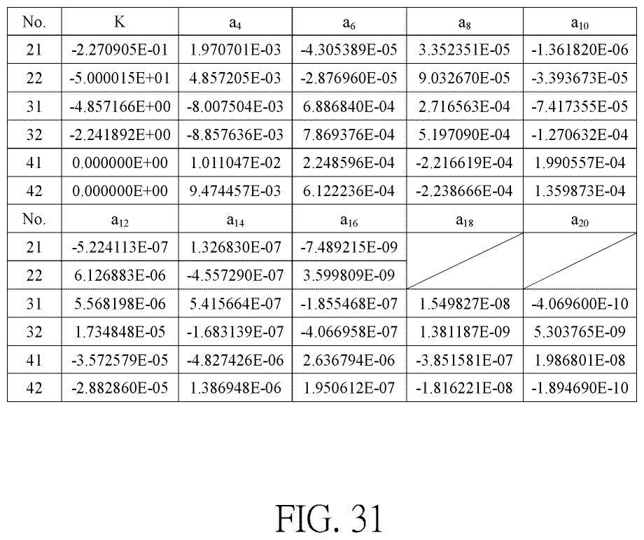

The optical data of the fifth embodiment of the optical imaging lens are shown in FIG. 30 while the aspheric surface data are shown in FIG. 31 In this embodiment, EFL=14.238 mm; HFOV=13.708 degrees; TTL=19.025 mm; Fno=2.800; ImgH=3.525 mm. In particular: 1. The system length TTL of this embodiment is shorter than that of the first embodiment; 2. The longitudinal spherical aberration of this embodiment is smaller than that of the first embodiment; 3. The field curvature aberration on the sagittal direction of this embodiment is smaller than that on the sagittal direction of the first embodiment; 4. The field curvature aberration on the tangential direction of this embodiment is smaller than that on the tangential direction of the first embodiment; 5. The distortion aberration of this embodiment is better than that of the first embodiment.

### Sixth Embodiment

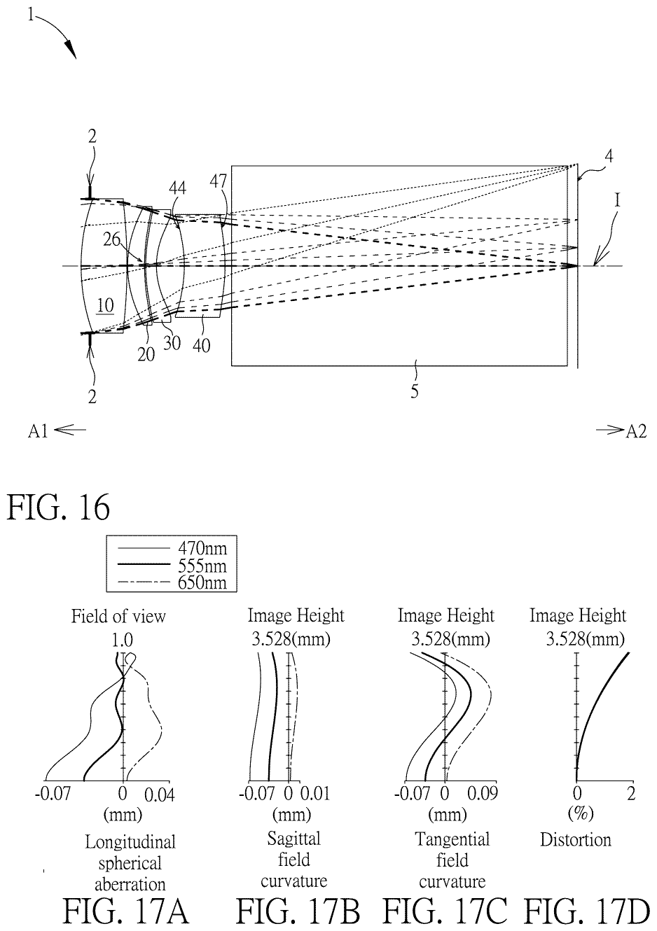

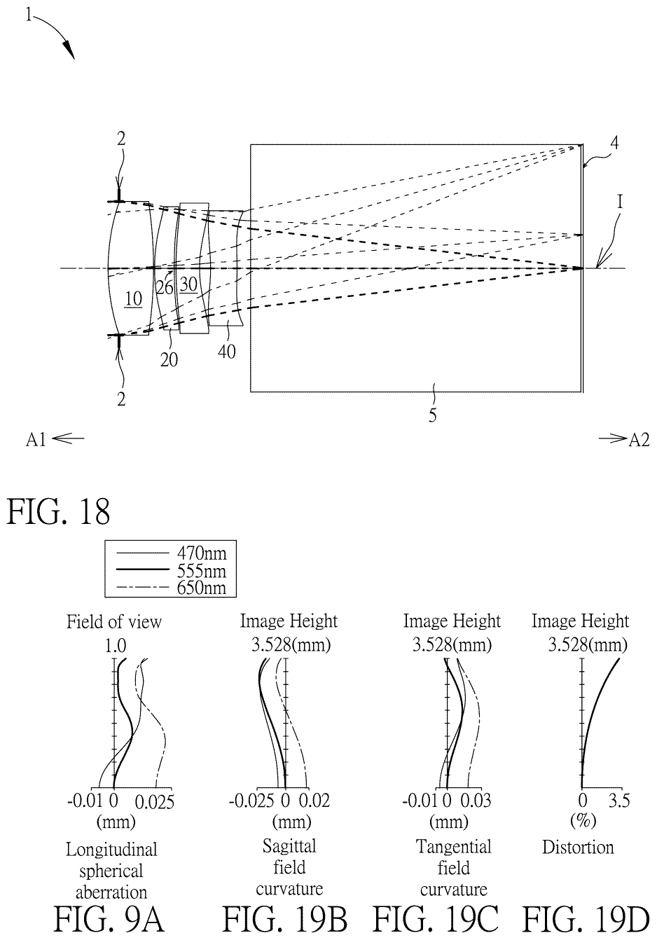

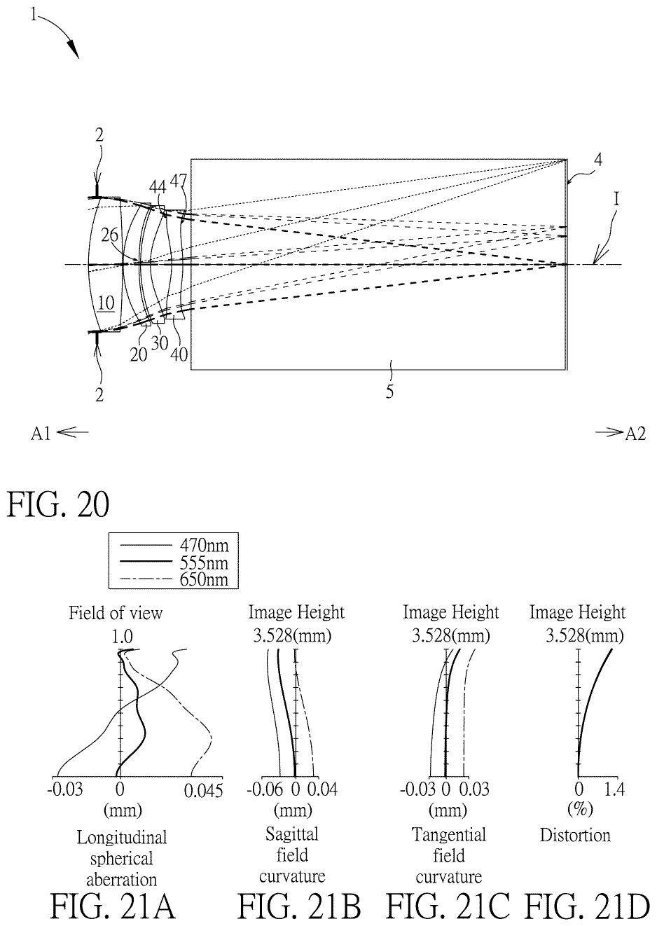

Please refer to FIG. 16 which illustrates the sixth embodiment of the optical imaging lens 1 of the present invention. Please refer to FIG. 17A for the longitudinal spherical aberration on the image plane 4 of the sixth embodiment; please refer to FIG. 17B for the field curvature aberration on the sagittal direction; please refer to FIG. 17C for the field curvature aberration on the tangential direction, and please refer to FIG. 17D for the distortion aberration. The components in this embodiment are similar to those in the first embodiment, but the optical data such as the radius of curvature, the lens thickness, the aspheric surface or the back focal length in this embodiment are different from the optical data in the first embodiment. In addition, in this embodiment, the optical axis region 26 of the image-side surface 22 of the second lens element 20 is concave, the periphery region 44 of the object side 41 of the fourth lens element 40 is concave, and the periphery region 47 of the image-side surface 42 of the fourth lens element 40 is convex.

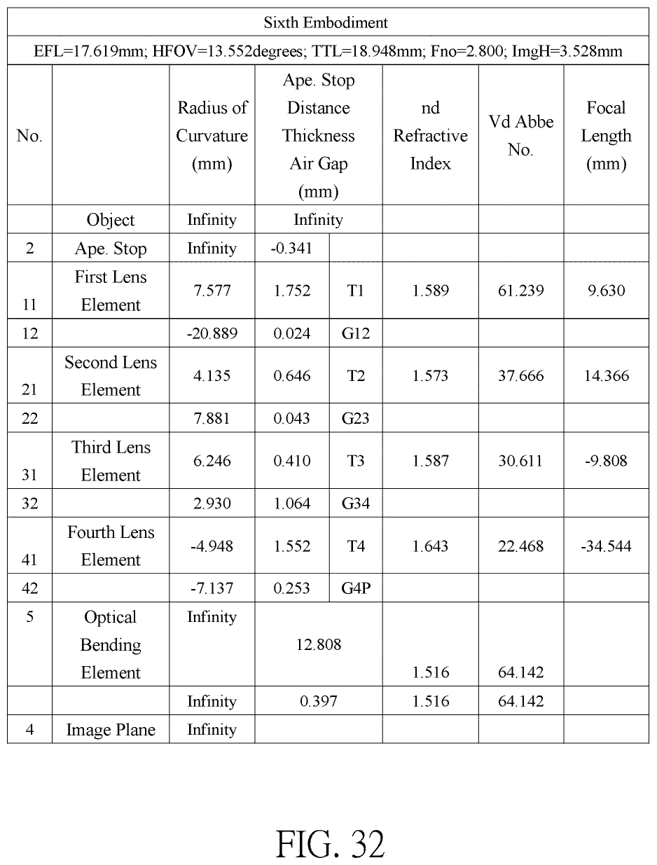

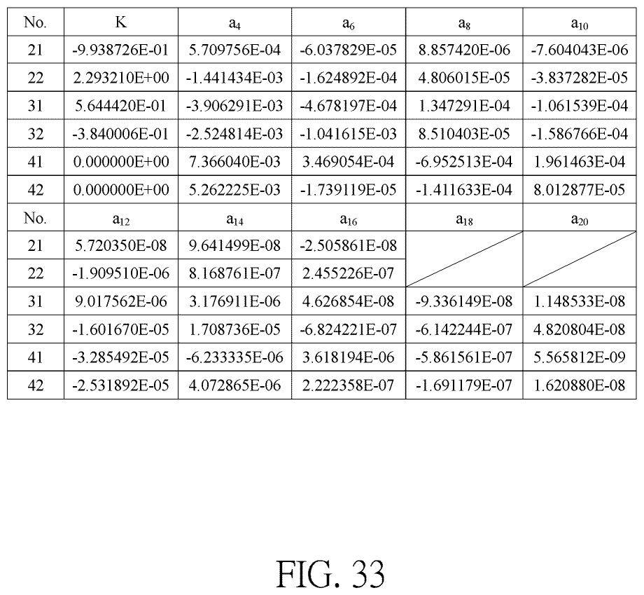

The optical data of the sixth embodiment of the optical imaging lens are shown in FIG. 32 while the aspheric surface data are shown in FIG. 33. In this embodiment, EFL=17.619 mm; HFOV=13.552 degrees; TTL=18.948 mm; Fno=2.800; ImgH-3.528 mm. In particular: 1. The system length TTL of this embodiment is shorter than that of the first embodiment; 2. The longitudinal spherical aberration of this embodiment is smaller than that of the first embodiment.

### Seventh Embodiment

Please refer to FIG. 18 which illustrates the seventh embodiment of the optical imaging lens 1 of the present invention. Please refer to FIG. 19A for the longitudinal spherical aberration on the image plane 4 of the seventh embodiment; please refer to FIG. 19B for the field curvature aberration on the sagittal direction; please refer to FIG. 19C for the field curvature aberration on the tangential direction, and please refer to FIG. 19D for the distortion aberration. The components in this embodiment are similar to those in the first embodiment, but the optical data such as the radius of curvature, the lens thickness, the aspheric surface or the back focal length in this embodiment are different from the optical data in the first embodiment. In addition, in this embodiment, the optical axis region 26 of the image-side surface 22 of the second lens element 20 is concave.

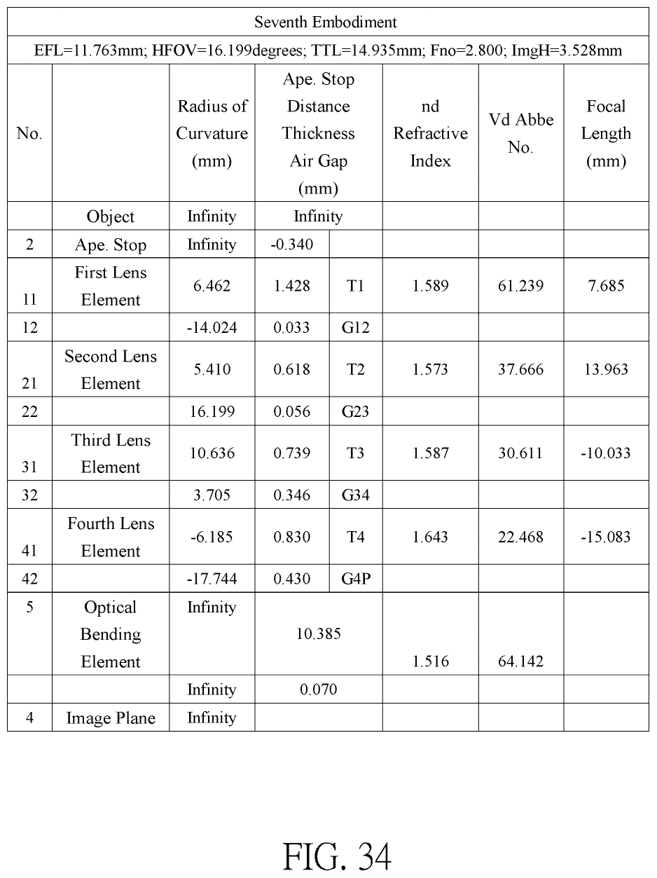

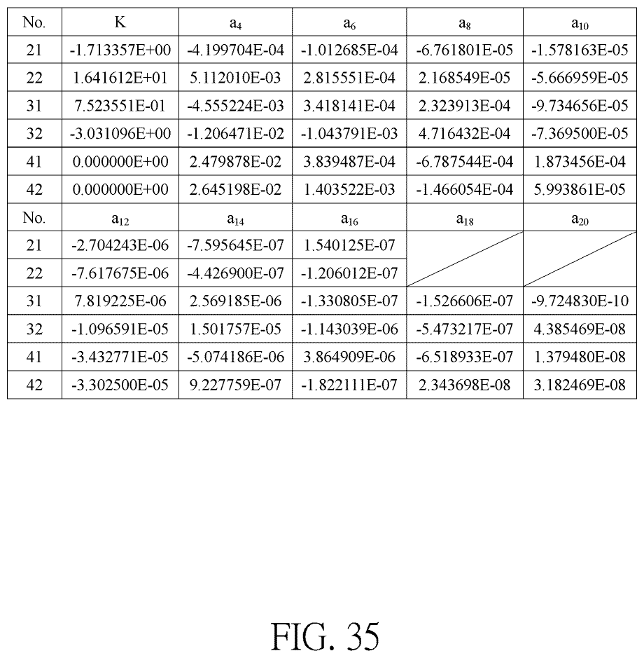

The optical data of the seventh embodiment of the optical imaging lens are shown in FIG. 34 while the aspheric surface data are shown in FIG. 35. In this embodiment, EFL=11.763 mm; HFOV=16.199 degrees; TTL=14.935 mm; Fno=2.800; ImgH=3.528 mm. In particular: 1. The system length TTL of this embodiment is shorter than that of the first embodiment; 2. The longitudinal spherical aberration of this embodiment is smaller than that of the first embodiment; 3. The field curvature aberration on the sagittal direction of this embodiment is smaller than that on the sagittal direction of the first embodiment; 4. The field curvature aberration on the tangential direction of this embodiment is smaller than that on the tangential direction of the first embodiment; 5. The distortion aberration of this embodiment is better than that of the first embodiment.

### Eighth Embodiment

Please refer to FIG. 20 which illustrates the eighth embodiment of the optical imaging lens 1 of the present invention. Please refer to FIG. 21A for the longitudinal spherical aberration on the image plane 4 of the eighth embodiment; please refer to FIG. 21B for the field curvature aberration on the sagittal direction; please refer to FIG. 21C for the field curvature aberration on the tangential direction, and please refer to FIG. 21D for the distortion aberration. The components in this embodiment are similar to those in the first embodiment, but the optical data such as the radius of curvature, the lens thickness, the aspheric surface or the back focal length in this embodiment are different from the optical data in the first embodiment. In addition, in this embodiment, the optical axis region 26 of the image-side surface 22 of the second lens element 20 is concave, and the periphery region 44 of the object-side surface 41 of the fourth lens element 40 is concave.

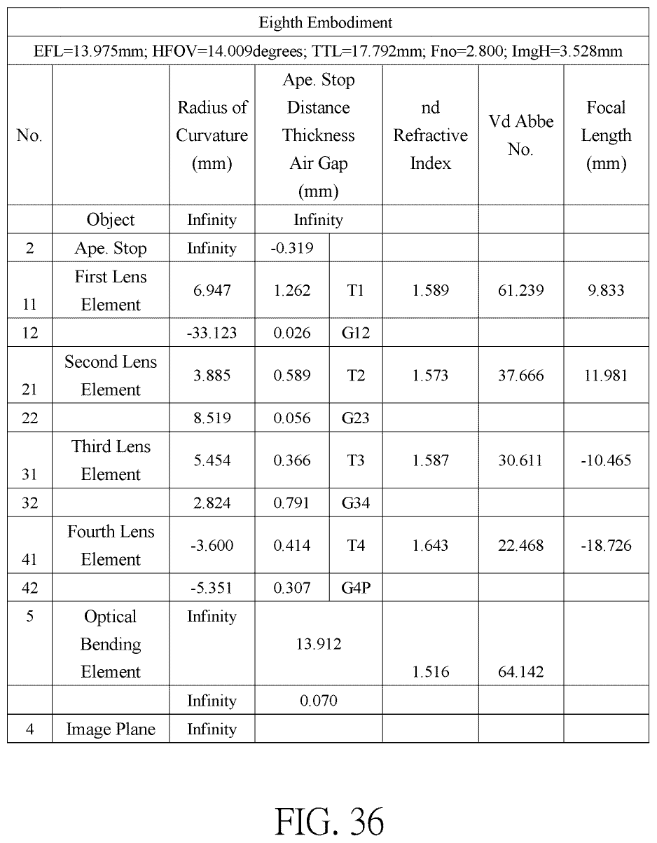

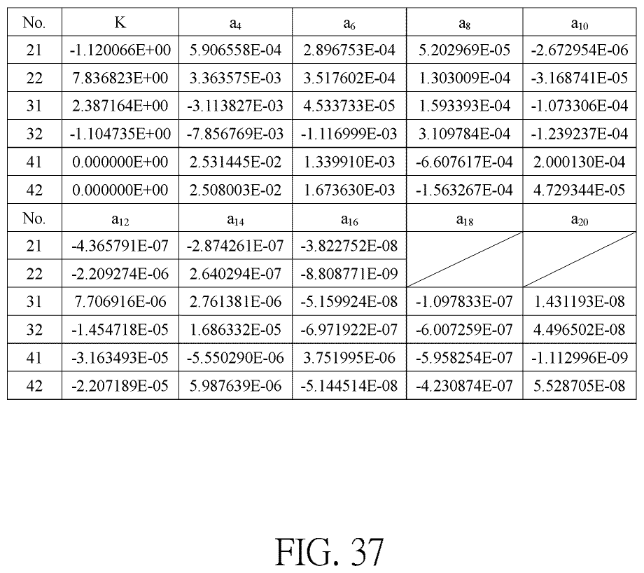

The optical data of the eighth embodiment of the optical imaging lens are shown in FIG. 36 while the aspheric surface data are shown in FIG. 37. In this embodiment, EFL=13.975 mm; HFOV=14.009 degrees; TTL=17.792 mm; Fno=2.800; ImgH=3.528 mm. In particular: 1. The system length TTL of this embodiment is shorter than that of the first embodiment; 2. The longitudinal spherical aberration of this embodiment is smaller than that of the first embodiment; 3. The field curvature aberration on the sagittal direction of this embodiment is smaller than that on the sagittal direction of the first embodiment; 4. The field curvature aberration on the tangential direction of this embodiment is smaller than that on the tangential direction of the first embodiment; 5. The distortion aberration of this embodiment is better than that of the first embodiment.

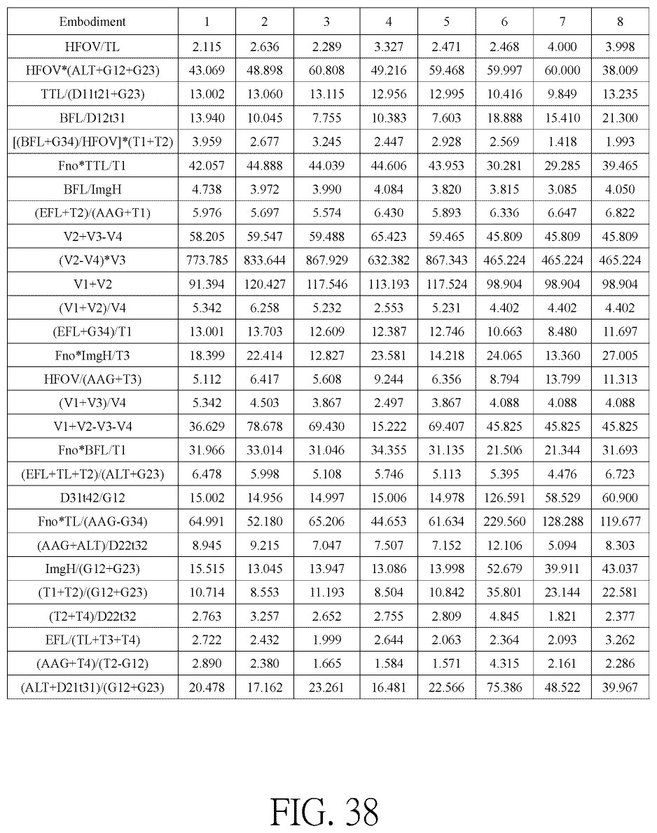

Some important ratios in each embodiment are shown in FIG. 38.

Each embodiment of the invention has the following effects:
1. When the optical imaging lens of the present invention satisfies the conditions that the third lens element 30 has negative refracting power and the fourth lens element 40 has negative refracting power, it can converge rays with different angles, and with the condition that the optical axis region 46 of the image-side surface 42 of the fourth lens element 40 is convex, it can correct the aberration of the central field of view of the image plane, and in addition, the surface shape of the specific lens periphery region, for example, the periphery region 34 of the object-side surface 31 of the third lens element 30 is convex and the optical axis region 36 of the image side 32 of the third lens element 30 is concave, which can further correct the distortion of the periphery field of view, and through the matching of half of view angle and lens length, when the optical imaging lens satisfies the condition of HFOV/TL≤4.000 degrees/mm, it can not only increase the focal length of the system, but also maintain the imaging quality, and the preferable range of HFOV/TL is 1.900≤HFOV/TL≤4.000 degrees/mm.
2. Based on the first point mentioned above, when the optical imaging lens further satisfies that the first lens element 10 has positive refracting power and the second lens element 20 has positive refracting power, the assembly yield can be improved.
3. When the optical imaging lens of the present invention satisfies the conditions that the third lens element 30 has negative refracting power and the fourth lens element 40 has negative refracting power, it can converge rays with different angles, and the aberration of the central field of view of the image plane can be corrected in accordance with the conditions that the optical axis region 23 of the object-side surface 21 of the second lens element 20 is convex, the periphery region 34 of the object-side surface 31 of the third lens element 30 is convex, and the optical axis region 46 of the image-side surface 42 of the fourth lens element 40 is convex. And through the matching of half of view angle, lens thickness and air gap, when the optical imaging lens satisfies the condition of HFOV*(ALT+G12+G23)≤60.000 degrees·mm, it can not only increase the focal length of the system, but also maintain the imaging quality, among which the preferable range of HFOV*(ALT+G12+G23) is 34.000≤HFOV*(ALT+G12+G23)≤60.000 degrees·mm.
4. Based on the third point mentioned above, when the optical imaging lens further satisfies the conditions that the first lens element 10 has positive refracting power and the second lens element 20 has positive refracting power, the spherical aberration caused by the first lens element 10 and the second lens element 20 can be balanced.
5. When the optical imaging lens of the present invention satisfies the conditions that the third lens element 30 has negative refracting power and the fourth lens element 40 has negative refracting power, it can converge rays with different angles, matching with the periphery region 34 of the object-side surface 31 of the third lens element 30 is convex, and the optical axis region 46 of the image-side surface 42 of the fourth lens element 40 is convex, so that the aberration of the central field of view of the image plane can be corrected, and through the matching of half of view angle and lens length, when the optical imaging lens satisfies the conditions of HFOV/TL≤4.000 degrees/mm and HFOV*(ALT+G12+G23)≤60.000 degrees·mm, not only the focal length of the system can be effectively increased, but also the assembly yield can be improved. The preferable ranges of HFOV/TL and HFOV*(ALT+G12+G23) are 1.900≤HFOV/TL≤4.000 degrees/mm, 34.000≤HFOV*(ALT+G12+G23)≤60.000 degrees·mm, respectively.
6. Based on the fifth point mentioned above, when the optical imaging lens further satisfies the conditions that the first lens element 10 has positive refracting power and the second lens element 20 has positive refracting power, the manufacturing yield can be improved.
7. When the lens material satisfy the configuration condition shown in Table 1 below, it is beneficial to the transmission and deflection of imaging rays, and at the same time, it can effectively improve the chromatic aberration, so that the optical imaging lens has excellent optical quality.

TABLE 1

| Condition | Preferable range |
|---|---|
| V2 + V3 − V4 ≥ 45.000 | 72.000 ≥ V2 + V3 − V4 ≥ 45.000 |
| (V2 − V4)*V3 ≥ 465.000 | 955.000 ≥ (V2 − V4)*V3 ≥ 465.000 |
| V1 + V2 ≥ 90.000 | 132.000 ≥ V1 + V2 ≥ 90.000 |
| (V1 + V2)/V4 ≥ 2.500 | 6.800 ≥ (V1 + V2)/V4 ≥ 2.500 |
| (V1 + V3)/V4 ≥ 2.500 | 5.900 ≥ (V1 + V3)/V4 ≥ 2.500 |
| V1 + V2 − V3 − V4 ≥ | 86.500 ≥ V1 + V2 − V3 − V4 ≥ |
| 15.000 | 15.000 |

8. In order to increase the focal length of the system and ensure the imaging quality, and at the same time consider the difficulty of manufacturing, if the numerical limit of the condition shown in Table 2 below is satisfied, the embodiment of the present invention can have a better configuration by reducing an air gap between lens elements or moderately shortening the lens thickness.

TABLE 2

| Condition | Preferable range |
|---|---|
| HFOV/TL ≤ 4.000 degrees/mm | 1.900 ≤ HFOV/TL ≤ 4.000 degrees/mm |
| HFOV*(ALT + G12 + G23) ≤ 60.000 | 34.000 ≤ HFOV*(ALT + G12 + G23) ≤ |
| degrees · mm | 60.000 degrees · mm |
| TTL/(D11t21 + G23) ≥ 9.500 | 14.500 ≥ TTL/(D11t21 + G23) ≥ 9.500 |
| BFL/D12t31 ≥ 7.500 | 23.400 ≥ BFL/D12t31 ≥ 7.500 |
| [(BFL + G34)/HFOV]*(T1 + T2) ≥ 1.400 | 4.400 ≥ [(BFL + G34)/HFOV]*(T1 + T2) ≥ 1.400 |
| mm²/degrees | mm²/degrees |
| Fno*TTL/T1 ≥ 30.000 | 49.000 ≥ Fno*TTL/T1 ≥ 30.000 |
| BFL/ImgH ≥ 3.000 | 5.200 ≥ BFL/ImgH ≥ 3.000 |
| (EFL + T2)/(AAG + T1) ≥ 5.500 | 7.500 ≥ (EFL + T2)/(AAG + T1) ≥ 5.500 |
| (EFL + G34)/T1 ≥ 8.500 | 15.000 ≥ (EFL + G34)/T1 ≥ 8.500 |
| Fno*ImgH/T3 ≥ 12.800 | 29.700 ≥ Fno*ImgH/T3 ≥ 12.800 |
| HFOV/(AAG + T3) ≤ 13.800 degrees/mm | 4.600 ≤ HFOV/(AAG + T3) ≤ 13.800 degrees/mm |
| Fno*BFL/T1 ≥ 20.000 | 37.800 ≥ Fno*BFL/T1 ≥ 20.000 |
| (EFL + TL + T2)/(ALT + G23) ≥ 4.400 | 7.400 ≥ (EFL + TL + T2)/(ALT + G23) ≥ 4.400 |
| D31t42/G12 ≥ 15.000 | 139.000 ≥ D31t42/G12 ≥ 15.000 |
| Fno*TL/(AAG − G34) ≥ 44.000 | 250.000 ≥ Fno*TL/(AAG − G34) ≥ 44.000 |
| (AAG + ALT)/D22t32 ≥ 5.000 | 13.300 ≥ (AAG + ALT)/D22t32 ≥ 5.000 |
| ImgH/(G12 + G23) ≥ 13.000 | 58.000 ≥ ImgH/(G12 + G23) ≥ 13.000 |
| (T1 + T2)/(G12 + G23) ≥ 8.500 | 40.000 ≥ (T1 + T2)/(G12 + G23) ≥ 8.500 |
| (T2 + T4)/D22t32 ≥ 1.800 | 5.300 ≥ (T2 + T4)/D22t32 ≥ 1.800 |
| EFL/(TL + T3 + T4) ≥ 2.000 | 3.600 ≥ EFL/(TL + T3 + T4) ≥ 2.000 |
| (AAG + T4)/(T2 − G12) ≤ 4.400 | 1.400 ≤ (AAG + T4)/(T2 − G12) ≤ 4.400 |
| (ALT + D21t31)/(G12 + G23) ≥ 16.400 | 83.000 ≥ (ALT + D21t31)/(G12 + G23) ≥ 16.400 |

In addition, any arbitrary combination of the parameters of the embodiments can be selected to increase the lens limitation so as to facilitate the design of the same structure of the present invention.

In the light of the unpredictability of the optical imaging lens, the present invention suggests the above principles to have a shorter system length of the optical imaging lens, a larger aperture, a larger field of view, better imaging quality or a better fabrication yield to overcome the drawbacks of prior art. The lens elements of the embodiment of the invention are made of plastic material, which can reduce the lens weight and save the cost.

The numerical range including the maximum and minimum values obtained from the combination proportional relationship of optical parameters disclosed in various embodiments of the present invention can be implemented accordingly.

The contents in the embodiments of the invention include but are not limited to a focal length, a thickness of a lens element, a Vd Abbe number, or other optical parameters. For example, in the embodiments of the invention, an optical parameter A and an optical parameter B are disclosed, wherein the ranges of the optical parameters, comparative relation between the optical parameters, and the range of a condition covered by a plurality of embodiments are specifically explained as follows:
(1) The ranges of the optical parameters are, for example, α2≤A≤α1 or β2≤B≤β1, where α1 is a maximum value of the optical parameter A among the plurality of embodiments, α2 is a minimum value of the optical parameter A among the plurality of embodiments, β1 is a maximum value of the optical parameter B among the plurality of embodiments, and β2 is a minimum value of the optical parameter B among the plurality of embodiments.
(2) The comparative relation between the optical parameters is that A is greater than B or A is less than B, for example.
(3) The range of a condition covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)1/2, and E satisfies a condition E≤γ1 or E≥γ2 or γ2≤E≤γ1, where each of γ1 and γ2 is a value obtained by an operation of the optical parameter A and the optical parameter B in a same embodiment, γ1 is a maximum value among the plurality of the embodiments, and γ2 is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a condition or the like, or a combination thereof. The description of the embodiments is for explaining the specific embodiments of the principles of the invention, but the invention is not limited thereto. Specifically, the embodiments and the drawings are for exemplifying, but the invention is not limited thereto.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens, from an object side to an image side in order along an optical axis comprising: a first lens element, a second lens element, a third lens element and a fourth lens element, the first lens element to the fourth lens element each having an object-side surface facing toward the object side and allowing imaging rays to pass through as well as an image-side surface facing toward the image side and allowing the imaging rays to pass through, wherein:
the third lens element has negative refracting power;
a periphery region of the object-side surface of the third lens element is convex;
an optical axis region of the image-side surface of the third lens element is concave;
the fourth lens element has negative refracting power;
an optical axis region of the image-side surface of the fourth lens element is convex;
lens elements included by the optical imaging lens are only the four lens elements described above, and the optical imaging lens satisfies the following condition: HFOV/TL≤4.000 degrees/mm, where HFOV is defined as a half field of view of the optical imaging lens, and TL is defined as a distance from the object-side surface of the first lens element to the image-side surface of the fourth lens element along the optical axis.

2. The optical imaging lens according to claim 1, wherein TTL is defined as a distance from the object-side surface of the first lens element to an image plane along the optical axis, D11t21 is defined as a distance from the object-side surface of the first lens element to the object-side surface of the second lens element along the optical axis, G23 is an air gap between the second lens element and the third lens element along the optical axis, and the optical imaging lens satisfies the following condition: TTL/(D11t21+G23)≥9.500.

3. The optical imaging lens according to claim 1, wherein BFL is defined as a distance from the image-side surface of the fourth lens element to an image plane along the optical axis, G34 is defined as an air gap between the third lens element and the fourth lens element along the optical axis, T1 is defined as a thickness of the first lens element along the optical axis, T2 is defined as a thickness of the second lens element along the optical axis, and the optical imaging lens satisfies the following condition: [(BFL+G34)/HFOV]*(T1+T2)≥1.400 mm²/degrees.

4. The optical imaging lens according to claim 1, wherein Fno is defined as a f-number of the optical imaging lens, TTL is defined as a distance from the object-side surface of the first lens element to an image plane along the optical axis, T1 is defined as a thickness of the first lens element along the optical axis, and the optical imaging lens satisfies the following condition: Fno*TTL/T1≥30.000.

5. The optical imaging lens according to claim 1, wherein BFL is defined as a distance from the image-side surface of the fourth lens element to an image plane along the optical axis, ImgH is defined as an image height of the optical imaging lens, and the optical imaging lens satisfies the following condition: BFL/ImgH≥3.000.

6. The optical imaging lens according to claim 1, wherein EFL is defined as an effective focal length of the optical imaging lens, T1 is defined as a thickness of the first lens element along the optical axis, T2 is defined as a thickness of the second lens element along the optical axis, and AAG is defined as a sum of three air gaps from the first lens element to the fourth lens element along the optical axis, and the optical imaging lens satisfies the following condition: (EFL+T2)/(AAG+T1)≥5.500.

7. The optical imaging lens according to claim 1, wherein V2 is defined as a Vd Abbe number of the second lens element, V3 is defined as a Vd Abbe number of the third lens element, V4 is defined as a Vd Abbe number of the fourth lens element, and the optical imaging lens satisfies the following condition: V2+V3−V4≥45.000.

8. An optical imaging lens, from an object side to an image side in order along an optical axis comprising: a first lens element, a second lens element, a third lens element and a fourth lens element, the first lens element to the fourth lens element each having an object-side surface facing toward the object side and allowing imaging rays to pass through as well as an image-side surface facing toward the image side and allowing the imaging rays to pass through, wherein:
an optical axis region of the object-side surface of the second lens element is convex;
the third lens element has negative refracting power;
a periphery region of the object-side surface of the third lens element is convex;
the fourth lens element has negative refracting power;
an optical axis region of the image-side surface of the fourth lens element is convex;
lens elements included by the optical imaging lens are only the four lens elements described above, and the optical imaging lens satisfies the following condition: HFOV*(ALT+G12+G23)≤60.000 degrees·mm, wherein HFOV is defined as a half field of view the optical imaging lens, ALT is defined as a sum of the thicknesses of the four lens elements from the first lens element to the fourth lens element along the optical axis, G12 is defined as an air gap between the first lens element and the second lens element along the optical axis and G23 is an air gap between the second lens element and the third lens element along the optical axis.

9. The optical imaging lens according to claim 8, wherein V2 is defined as a Vd Abbe number of the second lens element, V3 is defined as a Vd Abbe number of the third lens element, V4 is defined as a Vd Abbe number of the fourth lens element, and the optical imaging lens satisfies the following condition: (V2−V4)*V3≥465.000.

10. The optical imaging lens according to claim 8, wherein V1 is defined as a Vd Abbe number of the first lens element, V2 is defined as a Vd Abbe number of the second lens element, and the optical imaging lens satisfies the following condition: V1+V2≥90.000.

11. The optical imaging lens according to claim 8, wherein V1 is defined as a Vd Abbe number of the first lens element, V2 is defined as a Vd Abbe number of the second lens element, and V4 is defined as a Vd Abbe number of the fourth lens element, and the optical imaging lens satisfies the following condition: (V1+V2)/V4≥2.500.

12. The optical imaging lens according to claim 8, wherein EFL is defined as an effective focal length of the optical imaging lens, G34 is defined as an air gap between the third lens element and the fourth lens element along the optical axis, T1 is defined as a thickness of the first lens element along the optical axis, and the optical imaging lens satisfies the following condition: (EFL+G34)/T1≥8.500.

13. The optical imaging lens according to claim 8, wherein Fno is defined as a f-number of the optical imaging lens, ImgH is defined as an image height of the optical imaging lens, T3 is defined as a thickness of the third lens element along the optical axis, and the optical imaging lens satisfies the following condition: Fno*ImgH/T3≥12.800.

14. The optical imaging lens according to claim 8, wherein AAG is defined as a sum of three air gaps from the first lens element to the fourth lens element along the optical axis, T3 is defined as a thickness of the third lens element along the optical axis, and the optical imaging lens satisfies the following condition: HFOV/(AAG+T3)≤13.800 degrees/mm.

15. An optical imaging lens, from an object side to an image side in order along an optical axis comprising: a first lens element, a second lens element, a third lens element and a fourth lens element, the first lens element to the fourth lens element each having an object-side surface facing toward the object side and allowing imaging rays to pass through as well as an image-side surface facing toward the image side and allowing the imaging rays to pass through, wherein:
the third lens element has negative refracting power;
a periphery region of the object-side surface of the third lens element is convex;
the fourth lens element has negative refracting power;
an optical axis region of the image-side surface of the fourth lens element is convex;
lens elements included by the optical imaging lens are only the four lens elements described above, and the optical imaging lens satisfies the following conditions: HFOV/TL≤4.000 degrees/mm and HFOV*(ALT+G12+G23)≤60.000 degrees/mm, where HFOV is defined as a half field of view the optical imaging lens, TL is defined as a distance from the object-side surface of the first lens element to the image-side surface of the fourth lens element along the optical axis, ALT is defined as a sum of the thicknesses of the four lens elements from the first lens element to the fourth lens element along the optical axis, G12 is defined as an air gap between the first lens element and the second lens element, and G23 is defined as an air gap between the second lens element and the third lens element along the optical axis.

16. The optical imaging lens according to claim 15, wherein T2 is defined as a thickness of the second lens element along the optical axis, T4 is defined as a thickness of the fourth lens element along the optical axis, D22t32 is defined as a distance from the image-side surface of the second lens element to the image-side surface of the third lens element along the optical axis, and the optical imaging lens satisfies the following condition: (T2+T4)/D22t32≥1.800.

17. The optical imaging lens according to claim 15, wherein BFL is defined as a distance from the image-side surface of the fourth lens element to an image plane along the optical axis, D12t31 is defined as a distance from the image-side surface of the first lens element to the object-side surface of the third lens element along the optical axis, and the optical imaging lens satisfies the following condition: BFL/D12t31≥7.500.

18. The optical imaging lens according to claim 15, wherein V1 is defined as a Vd Abbe number of the first lens element, V3 is defined as a Vd Abbe number of the third lens element, V4 is defined as a Vd Abbe number of the fourth lens element, and the optical imaging lens satisfies the following condition: (V1+V3)/V4≥2.500.

19. The optical imaging lens according to claim 15, wherein V1 is defined as a Vd Abbe number of the first lens element, V2 is defined as a Vd Abbe number of the second lens element, V3 is defined as a Vd Abbe number of the third lens element, V4 is defined as a Vd Abbe number of the fourth lens element, and the optical imaging lens satisfies the following condition: V1+V2−V3−V4≥15.000.

20. The optical imaging lens according to claim 15, wherein Fno is defined as a f-number of the optical imaging lens, BFL is defined as a distance from the image-side surface of the fourth lens element to an image plane along the optical axis, T1 is defined as a thickness of the first lens element along the optical axis, and the optical imaging lens satisfies the following condition: Fno*BFL/T1≥20.000.
